(19) United States
(12) Patent Application Publication
(10) Pub. No.: US 2008/0295938 A1
(43) Pub. Date: Dec. 4, 2008

(54) Tire/Wheel Assembly

(75) Inventor: Mitsuru Naito, Kanagawa-ken (JP)

Correspondence Address: Patrick G. Burns;Greer , Burns & Crain, Ltd., Suite 2500, 300 South Wacker Drive, Chicago, IL, 60606, US

(73) Assignee: The Yokohama Rubber Co., Ltd.

(21) Appl. No.: 10/567,093

(22) PCT Filed: Jun. 8, 2004
(86) PCT No.: PCT/JP04/07950

§ 371 Date: Feb. 3, 2006

(30) Foreign Application Priority Data
Aug. 21, 2003 (JP) 2003-297300

(51) Int. Cl. B60C 17/10; B60C 17/04

(52) U.S. Cl. 152/333.1

(57) ABSTRACT

Disclosed is a tire/wheel assembly allowed to still further enhance run-flat durability thereof with a simple configuration. A tire/wheel assembly of the present invention is a tire/wheel assembly where a run-flat support member inserted, coaxially with a rim, in a cavity portion of a pneumatic tire. The tire/wheel assembly is formed of a configuration where a retention groove for lubricant on an inner peripheral surface of the pneumatic tire is provided in a manner that the retention groove is faced at least to an apex of the run-flat support member.

### TECHNICAL FIELD

The present invention relates to a tire/wheel assembly, and more specifically, relates to a tire/wheel assembly where run-flat durability is enhanced.

### BACKGROUND ART

In response to the market demanding, a number of technologies have been proposed, which enable the tire to make an emergency run for around several hundred kilometers when a pneumatic tire goes flat while an automobile is moving.

Among the thus proposed technologies, a technology proposed in Patent Document 1 or the like is one which realizes run-flat traveling in a manner that, with a core being mounted on a rim inside a cavity portion of a pneumatic tire assembled with a rim, the pneumatic tire in a deflated condition is supported by the core. This run-flat support member (the core) is used in a manner that an annular body formed to have the same axis as the rim has is mounted on the rim in a state concentric with the rim. Consequently, the run-flat support member can be used as it is without adding any modification to an existing wheel/rim structure, and can be made acceptable to the market without bringing any serious confusion to the market.

The above tire/wheel assembly (tired wheel), when the tire goes flat, performs run-flat traveling while an inside of the tire with a decreased inner pressure is supported by an outer peripheral surface of the run-flat support member. However, during this run-flat traveling period, an interface between the inner surface of the tire and the run-flat support member generates heat due to friction and local pressures, and is increasingly damaged with increasing mileage of the run-flat traveling, whereby the run-flat traveling in a satisfactory condition eventually becomes impossible.

As a solution for such a problem as above, it is proposed that a lubricant filled tank be provided to an inside of a shell of the run-flat support member. However, in this proposal, a weight increase is inevitable since it is necessary to fill a reasonable amount of liquid lubricant in the tank, and therefore it cannot be necessarily considered that the proposal greatly contributes to run-flat durability. Furthermore, for the purpose of fixing the tank directly to the inside of the shell, it is necessary to have a strong and complex fixing structure in order that the tank does not drop off during the run-flat traveling. This point brings about a weight increase and a cost increase. Additionally, when the tired wheel is running, since the liquid lubricant flows around in the tank and becomes a cause for the tired wheel to be out of balance, it has a disadvantage that it thus can be a factor of deteriorating driving stability.

[Patent Document 1] Japanese patent application Kokai publication No. Hei 10-297226
[Patent Document 2] Japanese patent application Kokai publication No. 2001-163020

### DISCLOSURE OF THE INVENTION

An object of the present invention is to provide a tire/wheel assembly allowed to still further enhance run-flat durability thereof with a simple configuration.

A tire/wheel assembly of the present invention for achieving the above object includes any one of the following configurations (1) to (5):

(1) A tire/wheel assembly provided with a retention groove for lubricant on an inner peripheral surface of the pneumatic tire in a manner that the retention groove is faced at least to an apex of the run-flat support member, the tire/wheel assembly having a run-flat support member inserted, coaxially with a rim, in a cavity portion of a pneumatic tire;

(2) The tire/wheel assembly according to abovementioned (1), wherein a depth of the retention groove is in a range of 0.5 to 2 mm;

(3) The tire/wheel assembly according to any one of abovementioned (1) and (2), wherein a width of the retention groove is set in a manner that: each of one-side widths thereof is set in a range of 5 to 10 mm from a position facing the center of an apex of the run-flat support member in a width-wise direction thereof;

(4) The tire/wheel assembly according to any one of abovementioned (1) to (3), wherein any one of a fiber reinforced layer and a reinforcement rubber layer is inserted between a bottom of the retention groove and a carcass layer; and

(5) The tire/wheel assembly according to any one of abovementioned (1) to (4), wherein reinforcing cords of the fiber reinforced layer are tilted in an angle in a range of 45 to 90 degrees with respect to a circumferential direction of the tire.

A tire/wheel assembly of the present invention is provided with a retention groove for lubricant on an inner peripheral surface of the pneumatic tire in a manner that the retention groove is faced at least to an apex of the run-flat support member, so that the tire/wheel assembly has an effect whereby run-flat durability thereof can be enhanced by use of the lubricant in the retention groove with little weight increase and without bringing about complexion of a fixing structure for the lubricant as compared with the conventional case where the tank is provided.

Additionally, the lubricant is retained in a position facing the apex of the run-flat support member, so that the tire/wheel assembly has an effect whereby lubrication can be reliably performed since the lubricant is disabled from moving, because of centrifugal force generated when the tire rotates, to any other areas than the position facing the apex of the run-flat support member.

### BRIEF DESCRIPTION OF THE DRAWINGS

FIG. 1 is a cross-sectional view showing a main portion of a tire/wheel assembly configured of an embodiment of the present invention, taken along a meridian of a tire thereof.

FIG. 2 is a perspective view partially showing an inside of a pneumatic tire incorporated in the tire/wheel assembly in FIG. 1.

FIG. 3 is a cross-sectional view showing an example of a vicinity of a retention groove of a pneumatic tire incorporated in a tire/wheel assembly of the present invention, taken along a meridian of the tire.

FIG. 4 is a cross-sectional view showing another example of a vicinity of a retention groove of a pneumatic tire incorporated in a tire/wheel assembly of the present invention, taken along a meridian of the tire.

### EXPLANATION OF SYMBOLS

1: rim
2: pneumatic tire
3: run-flat support member
4: annular shell
4a and 4b: apexes
5: elastic ring
7: carcass layer
8: tread portion
9: belt layer
10: retention groove
11: inner liner
12: fiber reinforced layer
L: lubricant

### BEST MODE FOR CARRYING OUT THE INVENTION

In the present invention, a pneumatic tire is not particularly limited with respect to kinds thereof, and may be a radial tire or a bias tire. Moreover, the pneumatic tire may be any one of a tire for a passenger automobile, a tire for a pickup truck or a tire for heavy loading. However, preferably, the present invention may be applied to a tire for a passenger automobile and to a radial tire.

A run-flat support member is not particularly limited with respect to a structure thereof, as long as the run-flat support member is mountable without substantially modifying an existing rim, and has a function of supporting an inner surface of the pneumatic tire. However, the run-flat support member may be preferably one constituted of an annular shell and elastic rings as main parts.

That is, the annular shell forms a continuous supporting surface which supports the flat tire in an outer peripheral side (a radially outward side) thereof, and in an inner peripheral side (a radially inward side) thereof, a shape of astride legs in a two-pronged state is formed, the shape using left and right side walls thereof as the legs. A cross-sectional shape of the supporting surface in the outer peripheral side may be one formed to be a convex curved surface from within outward in a radial direction of the tire/wheel assembly, the cross-sectional shape being taken along a direction orthogonal to a circumferential direction thereof. The number of the convex portions in the outer peripheral side of the annular shell may be one or a plural number which is at least two. However, when the plural convex portions are provided, loading supported during run-flat traveling is scattered over the plural convex portions, whereby durability of the annular shell as a whole can be enhanced.

The elastic rings are respectively fixed to ends of the two legs in the two-pronged shape in the inner peripheral side of the annular shell, and support the annular shell by abutting left and right sides of a rim sheet. These elastic rings are formed of rubber or an elastic resin, stably support the annular shell by providing the annular shell with slip resistance against the rim sheet, and reduce shock and vibration received by the annular shell from the tire in a deflated condition.

Hereinbelow, the present invention will be specifically described with reference to the attached drawings.

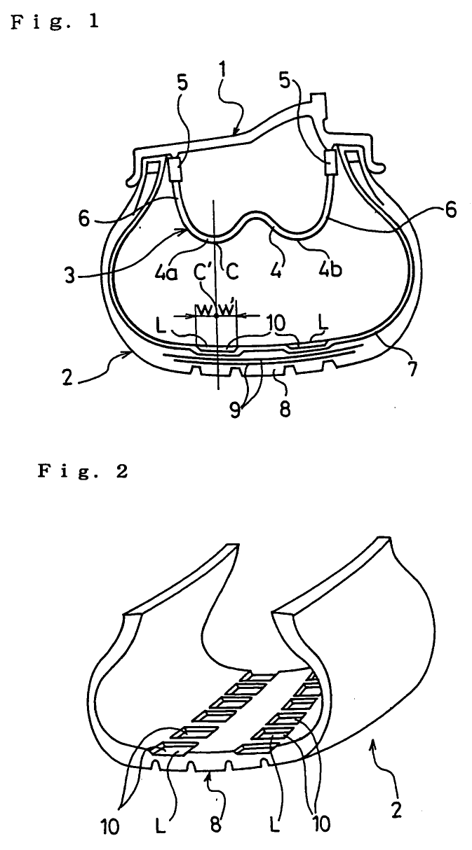

FIG. 1 is a cross-sectional view showing a main portion of a tire/wheel assembly (tired wheel) configured of an embodiment of the present invention, in a width-wise direction (taken along a meridian) of a tire thereof

Reference numerals 1, 2, and 3 denote a rim at an outer periphery of a wheel of the tire/wheel assembly, a pneumatic tire, and a run-flat support member, respectively. These rim 1, pneumatic tire 2 and run-flat support member 3 are formed respectively in ring shapes coaxially with one another, whose center is commonly an unillustrated rotational axis of the wheel.

The run-flat support member 3 is composed of an annular shell 4 and elastic rings 5, the annular shell 4 being formed of a stiff material such as a metal or a resin, and the elastic rings 5 being formed of an elastic material such as hard rubber or an elastic resin. The annular shell 4 is formed in a state where apexes 4a and 4b thereof are aligned in a width-wise direction of the tire, the apexes 4a and 4b formed of two convex curved surfaces. Additionally, both side walls in an inner peripheral side of the annular shell 4 become astride legs in a two-pronged form as legs 6, 6 respectively, and have the elastic rings 5, 5 fixed to ends thereof.

The pneumatic tire 2 includes: a carcass layer 7 having a radial structure inside; and a belt layer 9 arranged toward an outer peripheral side of the carcass layer 7 in a tread portion 8, the belt layer 9 formed of steel cords and the like. Additionally, a pair of left and right retention grooves 10, 10, which retain lubricant L, are formed on an inner peripheral surface of the pneumatic tire 2. These left and right retention grooves 10, 10 are arranged in order that they can face the apexes 4a and 4b of the run-flat support member 3. As shown in FIG. 2, each of these retention grooves 10 may be discontinuous or be continuous in a circumferential direction of the tire.

The lubricant L retained in the retention grooves 10 may be high in viscosity and low in fluidity, and is not particularly limited in other respects. For example, lubricant which mainly consists of grease or silicon oil can be preferably used.

The tire/wheel assembly (tired wheel) with the above configuration, when the pneumatic tire 2 goes flat while it is running, performs run-flat traveling by going into a state where portions of the retention grooves 10 of the inner peripheral surface are supported by the apexes 4a and 4b of the run-flat support member 3. Therefore, an interface between the pneumatic tire 2 and the run-flat support member 3 is lubricated by the lubricant L in the retention grooves 10, and thus mutual friction therebetween is suppressed, whereby a mileage traveled in a run-flat condition can be extended.

Furthermore, since centrifugal force is generated when the tire/wheel assembly rotates, the lubricant L is prone to flow toward a central portion of the inner peripheral surface in a width-direction of the tire, the central portion having a relatively large diameter on the inner peripheral surface of the tire. However, since the lubricant L is retained in the retention grooves 10 which are closed space, flows thereof which are prone to move toward the central portion in the width-direction of the tire are suppressed. Therefore, even when the tire rotates, the lubricant L is immobilized in portions corresponding to the apexes 4a and 4b of the run-flat support member 3, and constantly lubricates the interface between the pneumatic tire 2 and the run-flat support member 3. Thereby, run-flat durability of the tire/wheel assembly is still further enhanced.

In the present invention, the retention groove for retaining lubricant may be provided at least in a position facing to the apex of the run-flat support member. It is preferable that a groove depth d of the retention groove be set in a range of 0.5 to 2.0 mm. If the groove depth d is shallower than 0.5 mm, it becomes difficult to retain the lubricant in the retention groove against centrifugal force. If the groove depth d becomes deeper than 2.0 mm, that is not preferable because it becomes more likely that durability of the pneumatic tire is damaged by stress concentration on the retention groove.

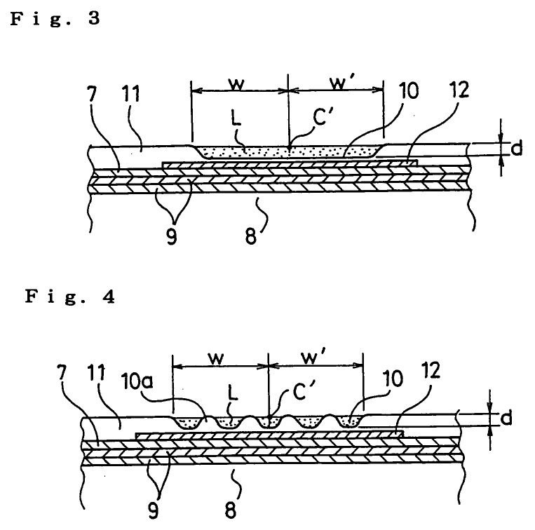

In a case where the groove depth d is made particularly deep (for example, in a range of 1.0 to 3.0 mm), as shown in FIG. 3, a fiber reinforced layer 12 or a reinforcement rubber layer of hard rubber or the like may be inserted into a region between the carcass layer 7 and an inner liner 11, the region corresponding to the retention groove 10. Reinforcing cords of the fiber reinforced layer 12 may be any cords having a reinforcement function, and is not particularly limited in other respects, and as the reinforcing cords, it is possible to use organic fiber cords, steel cords or the like. The reinforcing cords of the fiber reinforced layer 12 may be aligned in a direction tilted in an angle in a range of 45 to 90 degrees with respect to a circumferential direction of the tire. The above angle of the cords can not only reinforce the retention grooves 10, but also allow suppression of flows of the lubricant L to be accomplished by use of irregularities formed by the fiber cords on bottoms of the respective retention grooves 10.

With respect to a groove width of the retention groove, each of one-side widths w and w′ may be set in a range of 5 to 10 mm from a position C′ facing the center C of an apex of the run-flat support member in a width-wise direction thereof (refer to FIG. 1). If any one of the one-side widths w and w′ is smaller than 5.0 mm, that may bring about insufficiency in lubrication. Additionally, if any one of them is larger than 10.0 mm, that makes it difficult to immobilize the lubricant against the centrifugal force.

As effective means for suppressing the flows of the lubricant due to the centrifugal force, a multiple number of linear and/or punctiform salient portions 10a may be provided inside the retention groove 10 as shown in FIG. 4 as example. The flows of the lubricant L is suppressed by the multiple number of salient portions 10a thus provided in the retention groove 10, whereby an even more preferable lubricating operation can be performed.

A method of processing the retention groove is not particularly limited, and the method may be any one of methods: where, by providing a convex portion on an outer periphery of a curing bladder, this curing bladder is pressed against an inner peripheral surface of an unvulcanized tire when vulcanizing the tire; and where post-processing is applied by using a buff or the like. Otherwise, the method may be one where: with a strip material for covering a belt, a central portion of an outer peripheral surface of the belt layer is wrapped in a circumferential direction of a tire to have a wrapped width in a range of 10 to 20 mm, a recesses are formed in portions on an inner surface of the tire which correspond to portions to both sides of the thus wrapped portions.

### INDUSTRIAL ALPPLICABILITY

The tire/wheel assembly of the present invention can be utilized in the tire industry, and by extension can be effectively utilized in the automobile industry as a tire/wheel assembly for realizing run-flat traveling.

1. A tire/wheel assembly where a run-flat support member is inserted, coaxially with a rim, in a cavity portion of a pneumatic tire, wherein a retention groove for lubricant on an inner peripheral surface of the pneumatic tire is provided in a manner that the retention groove is faced at least to an apex of the run-flat support member.

2. The tire/wheel assembly according to claim 1, wherein a depth of the retention groove is in a range of 0.5 to 2.0 mm.

3. The tire/wheel assembly according to any one of claims 1 and 2, wherein a width of the retention groove is set in a manner that: each of one-side widths thereof is set in a range of 5.0 to 10.0 mm from a position facing the center of an apex of the run-flat support member in a width-wise direction thereof.

4. The tire/wheel assembly according to any one of claims 1 and 2, wherein any one of a fiber reinforced layer and a reinforcement rubber layer is inserted between a bottom of the retention groove and a carcass layer.

5. The tire/wheel assembly according to any one of claims 1 and 2, wherein reinforcing cords of the fiber reinforced layer are tilted in an angle in a range of 45 to 90 degrees with respect to a circumferential direction of the tire.
